(19) United States
(12) Patent Application Publication
(10) Pub. No.: US 2023/0385611 A1
(43) Pub. Date: Nov. 30, 2023

(54) APPARATUS AND METHOD FOR TRAINING PARAMETRIC POLICY

(71) Applicant: HUAWEI TECHNOLOGIES CO., LTD., Shenzhen (CN)

(72) Inventors: Vincent MOENS, London (GB); Hugues VAN ASSEL, Lyon (FR); Haitham BOU AMMAR, London (GB)

(21) Appl. No.: 18/364,601

(22) Filed: Aug. 3, 2023

Related U.S. Application Data
(63) Continuation of application No. PCT/EP2021/052683, filed on Feb. 4, 2021.

(51) Int. Cl. G06N 3/047

(52) U.S. Cl. CPC G06N 3/047

(57) ABSTRACT

An apparatus for training a parametric policy in dependence on a proposal distribution, the apparatus comprising one or more processors configured to repeatedly perform the steps of: forming, in dependence on the proposal distribution, a proposal; inputting the proposal to the policy so as to form an output state from the policy responsive to the proposal; estimating a loss between the output state and a preferred state responsive to the proposal; forming, by means of an adaptation algorithm and in dependence on the loss, a policy adaption; applying the policy adaption to the policy to form an adapted policy; forming, by means of the adapted policy, an estimate of variance in the policy adaptation and adapting the proposal distribution in dependence on the estimate of variance so as to reduce the variance of policy adaptations formed on subsequent iterations of the steps.

### CROSS-REFERENCE TO RELATED APPLICATIONS

This application is a continuation of International Application No. PCT/EP2021/052683, filed on Feb. 4, 2021, the disclosure of which is hereby incorporated by reference in its entirety.

### FIELD OF THE INVENTION

This invention relates to training parametric policies for use in reinforcement learning.

### BACKGROUND

Model-based reinforcement learning is a set of techniques developed to learn a control policy off-line, i.e. without directly interacting with the environment, which can be costly. The variance associated with gradient estimators is a ubiquitous problem in policy gradient reinforcement learning. In the context of model-based reinforcement learning, this problem can become even more serious when a stochastic model and policy are used to simulate the random trajectories used for the policy training.

Model-based reinforcement learning (MB-RL) can be conducted with deterministic or stochastic models of the environment. When compared with deterministic models, it is usually assumed that the policy benefits from transition model stochasticity by exploring probable and informative trajectories, due to these being either rewarded or costly, which would have been otherwise ignored. For a model which is not assumed to be perfect, the agent can cope with the incomplete knowledge of the environment to find the most profitable policy on expectation. Yet, when gradients retrieved from trajectory simulations are used to update the policy, the elimination of this bias comes at the price of a higher variance of the Monte-Carlo gradient estimates. A solution to this problem is to approximate the possibly multimodal distribution of the trajectories, for example, by a multivariate Gaussian using moment matching. Though this greatly simplifies the evaluation of the trajectory outcome, this can oversimplify the problem, especially in high dimensional problems and long-horizon tasks. It also requires the practitioner to use custom reward functions, sometimes violating the assumption that reward functions do not have an accessible analytical formula. Common variance reduction techniques, such as control variates, including baselines, or Rao-Blackwellisation, can partially reduce the variance of the simulated gradients, but their use must be tailored to the gradient estimator used. Specifically, they are mostly used with likelihood-ratio gradient estimators, and barely cope with the noise originating from the stochastic model.

Most existing MB-RL algorithms discard the problem of the gradient noise due to stochasticity of the model and policy. In Model-Free RL, this is an extensively studied problem, and multiple methods have been developed to deal with this, for example, proximal policy updates, policy optimization via importance sampling, etc.

An existing algorithm has been proposed to deal with this in the MB-RL context known as Probabilistic Inference for Particle-Based Policy Search (PIPPS). PIPPS uses a mixture of reparameterised and likelihood ratio gradient estimators. The noise reduction is achieved through a careful weighting of those two estimators. A set of particles is generated according to a non-parametric proposal distribution. In other words, PIPPS shows how to reduce variance of the update given a generated trajectory.

PIPPS also has a high computational cost. At each time step, the variance of the parameters for the step-wise update has to be computed, which for large models is unfeasible. In practice, PIPPS assumes that one has access to each gradient component, i.e. for each trajectory, step and particle; which is usually not treated as such by most ML libraries where gradients are fused and components are not accessible. Thus, accessing these gradients comes at a high computational cost.

As a result, PIPPS is hard to apply “off-the-shelf” to existing algorithms. It requires a significant effort to be coded, and its computational complexity is far greater than ours.

It is desirable to develop a method and device for implementing a method which reduces the gradient noise in a MB-RL environment while providing a faster and more sample efficient training of control algorithms based on stochastic gradient estimations.

### SUMMARY OF THE INVENTION

According to one aspect there is provided an apparatus for training a parametric policy in dependence on a proposal distribution, the apparatus comprising one or more processors configured to repeatedly perform the steps of: forming, in dependence on the proposal distribution, a proposal; inputting the proposal to the policy so as to form an output state from the policy responsive to the proposal; estimating a loss between the output state and a preferred state responsive to the proposal; forming, by means of an adaptation algorithm and in dependence on the loss, a policy adaption; applying the policy adaption to the policy to form an adapted policy; forming, by means of the adapted policy, an estimate of variance in the policy adaptation and adapting the proposal distribution in dependence on the estimate of variance so as to reduce the variance of policy adaptations formed on subsequent iterations of the steps.

The proposal may be a sequence of pseudo-random numbers. This can help to distribute the training stimuli of the system.

The proposal distribution may be a parametric proposal distribution. This can provide an efficient manner of expressing the proposal distribution.

The preferred state may represent an optimal or acceptable state that is responsive to the proposal. The preferred state may be a state defined by a predetermined algorithm and/or by ground truth information.

The step of adapting the proposal distribution may comprise adapting one or more parameters of the proposal distribution. This can provide an efficient manner of expressing the adaptation.

The steps may comprise: making a first estimation of noise in the policy adaptation; making a second estimation of the extent to which that noise is dependent on the proposal; and adapting the proposal distribution in dependence on the second estimation. This can provide an effective mechanism for improving the proposal distribution.

The proposal distribution may be adapted by a gradient variance estimator taking an estimate of variance in the policy adaptation as input. This can provide an effective mechanism for improving the proposal distribution.

The estimate of variance may be formed by a variance estimator. It may be a stochastic estimator. This can provide an effective measure of the variance.

The proposal may be formed by stochastically sampling the proposal distribution. This can allow the proposals of successive iterations to represent different states in the proposal distribution.

The adaptation algorithm may be such as to sample a trajectory in a manner such as to inhibit variance of the adaptation over successive iterations. This can accelerate the learning process.

An apparatus as claimed in any preceding claim, wherein the adaptation algorithm is such as to form policy gradients and to form the adaptation by stochastic optimisation of the policy gradients. This can provide an effective mechanism for improving the proposal distribution.

An apparatus as claimed in any preceding claim, wherein the parametric policy comprises a neural network model.

According to another aspect there is provided a method for training a parametric policy in dependence on a proposal distribution, the method comprising repeatedly performing the steps of: forming, in dependence on the proposal distribution, a proposal; inputting the proposal to the policy so as to form an output state from the policy responsive to the proposal; estimating a loss between the output state and a preferred state responsive to the proposal; forming, by means of an adaptation algorithm and in dependence on the loss, a policy adaption; applying the policy adaption to the policy to form an adapted policy; forming, by means of the adapted policy, an estimate of variance in the policy adaptation and adapting the proposal distribution in dependence on the estimate of variance so as to reduce the variance of policy adaptations formed on subsequent iterations of the steps.

According to another aspect there is provided a parametric policy formed by the apparatus or the method defined in the claims.

According to another aspect there is provided a processing apparatus comprising one or more processors configured to receive an input and process that input by means of a parametric policy as defined in the claims.

### BRIEF DESCRIPTION OF THE FIGURES

The present invention will now be described by way of example with reference to the accompanying drawings. In the drawings:

FIG. 1 shows the typical approach to model-based reinforcement learning;

FIG. 2 shows a flow chart of the proposed approach comprising a proposal distribution trained simultaneously with the policy and model; and

FIG. 3 shows a directed acyclic graph of the data generation process in a schematic form for FiRe trajectories.

### DETAILED DESCRIPTION OF THE INVENTION

In a reinforcement learning (RL) problem, an agent must decide how to sequentially select actions to maximize its total expected return. In contrast to classic stochastic optimal control methods, RL approaches do not require detailed prior knowledge of the system dynamics or goal. Instead, these approaches learn optimal control policies through interaction with the system itself. A policy specifies what the agent should do under all contingencies. An agent wants to find an optimal policy which maximizes its expected utility. A policy typically consists of a decision function for each decision variable. A decision function for a decision variable is a function that specifies a value for the decision variable for each assignment of values of its parents. Thus, a policy specifies what the agent will do for each possible value that it could sense.

RL problems are typically formalised as a Markov decision process (MDP), which comprises the potentially infinite state space, the action space, a state transition probability density function describing the task dynamics, a reward probability density function measuring the performance of the agent, and a discount factor. At each time step the agent is in a state and must choose an action, transitioning to a new state and yielding a reward. The sequence of state-action-reward triplets forms a trajectory over a (possibly infinite) horizon. A policy in this context specifies a conditional probability distribution over actions given the current state. The RL agent's goal is to find an optimal policy that maximizes total expected returns on expectation. Assuming there is a parametric family of policies, the agent's optimisation objective now translates into finding an optimal parameter configuration and can be formally stated mathematically as equation 1.

$${θ}^{⋆} = {arg max}_{θ} 𝒥 ( θ ) \qquad ( 1 )$$

$$where 𝒥 ( θ ) {=}^{△} {𝔼}_{{p}_{θ} ( τ )} [ 𝒢 ( τ ) ] ,$$

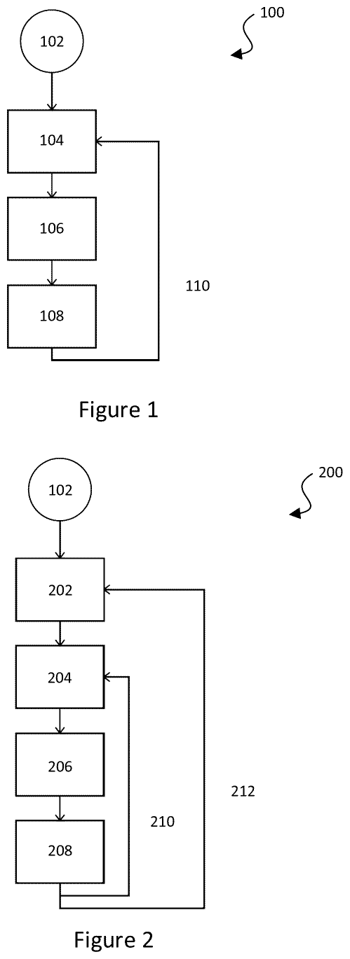

FIG. 1 shows the typical approach to the above-described scenario. Usually, a simulator 104, comprising a model of the environment, is used to generate imagined trajectories in model-based reinforcement learning. These imagined trajectories are then used to train the policy parameters to complete the task. The use of a model allows for the collection of as little data as possible from the environment, which can be costly to collect. In FIG. 1, the simulator 104 outputs the imagined trajectories which are then used to generate a return estimate 106. The generated return estimate 106 can then be used to determine the policy gradient 108. Once a policy gradient 108 has been determined, the policy can be updated 110 in such a way as to find the optimal policy as described above. The process typically starts with a specified starting state 102 from which the policy is optimized.

When the policy and the model are stochastic and Monte Carlo sampling is used to estimate the value of the policy gradient, the gradients are collected with a noise that is dictated by those distributions. It is a fundamental theorem of Monte Carlo sampling that the best distribution to use to sample trajectories which provide low-variance gradient updates is not the joint model and policy. However, no tool has been developed to sample trajectories according to this sequential importance sampling principle, where one would attempt to find the best distribution to achieve this efficient sampling.

The method proposed herein aims to reduce parameter gradient noise, also called variance, in model-based reinforcement learning. The propose method presents a sequential importance resampling (SIR) variance reduction algorithm in the context of MB-RL. The main aspect of the proposed method consists of a parametric proposal distribution trained simultaneously with the policy and model to minimise an estimator of the total variance of the policy parameters' average gradient and evaluated over simulated trajectories. To ensure that the proposed method does not result in additional variance by matching poorly to the state-action probability space defined by the model and policy, the proposal distribution is built on top of these components. If needed, the proposal can be made arbitrarily close to the joint surrogate probability distribution of the trajectories and is robust to changes in the mapping it encodes. When these distributions can be sampled from using a reparameterised auxiliary random variables with a known base distribution; for example, a Gaussian or uniform distribution; the proposal modifies this base distribution in such a way that the re-weighted trajectories have a lower average gradient variance than their original counterparts. Hence, in order to be implemented, the proposed method only requires that trajectories can be sampled with a mapping of an auxiliary random variable with a known distribution. A great deal of current RL architectures satisfy this condition, making the proposed approach versatile and flexible such that it can be applied to a wide range of models. The proposal may be formed by stochastically sampling the proposal distribution. In the proposed approach the adaptation algorithm may be such as to sample a trajectory in a manner such as to inhibit variance of the adaptation over successive iterations. The adaptation algorithm may be such as to form policy gradients and to form the adaptation by stochastic optimisation of the policy gradients.

The core concept of the proposed method is a parametric proposal distribution for policy gradient Model-Based RL which takes the form of a base distribution for the policy and a transition model in Model-Based Reinforcement Learning. This parametric proposal distribution is trained to generate auxiliary random variables that minimize the variance in the policy parameter gradients when these are passed through the model and policy to produce importance weighted trajectories. Thus, there is provided an efficient gradient-based method to train the proposal distribution.

There is therefore proposed herein a method and apparatus for training a parametric policy in dependence on a proposal distribution. The apparatus comprises one or more processors configured to repeatedly perform the following steps of the method. Forming, in dependence on the proposal distribution, a proposal. Inputting the proposal to the policy so as to form an output state from the policy responsive to the proposal. Estimating a loss between the output state and a preferred state responsive to the proposal. Forming, by means of an adaptation algorithm and in dependence on the loss, a policy adaption. Applying the policy adaption to the policy to form an adapted policy. Forming, by means of the adapted policy, an estimate of variance in the policy adaptation. Adapting the proposal distribution in dependence on the estimate of variance so as to reduce the variance of policy adaptations formed on subsequent iterations of the steps. Where the preferred state is a state which is highly rewarded, i.e. that corresponds to a desirable outcome of the policy undertaken.

The proposed method comprises a filtering algorithm which learns a parametric sampling distribution that produces low-variance gradient updates to the policy parameters. The parameters of the sampling distribution, also called the proposal distribution or simply the proposal, are optimized to minimize the value of the policy gradient variance across trajectories from a single starting state. This contrasts with existing methods which ignore the possibility of learning multi-modal sampling distributions. The proposal may be parametric in that the number of parameters would be fixed, unlike in non-parametric algorithms where the number of parameters is flexible and additional parameters can be added as the training proceeds. As such, the proposal distribution may be a parametric proposal distribution. The step of adapting the proposal distribution may therefore comprise adapting one or more parameters of the proposal distribution.

To this end, there are three components which may be used to achieve this objective. Firstly, an object, the proposal, that produces low-variance trajectories. Secondly, a computable loss function, i.e. a gradient variance estimator that is to be minimized on the fly during policy learning. Thirdly, a method to propagate gradients with respect to the proposal to minimize this loss.

The proposal of the proposed method is a parametric and flexible distribution that is conditioned on the start state, P0. It is assumed that the proposal can have reparameterised gradients of its own to facilitate learning. However, alternatively likelihood ratios could be used instead.

The loss is a total variance estimator of the policy gradient. That is, the loss is a sum of variances of single parameter partial derivative, which can be prohibitively expensive to compute exactly. Hence, the variance estimator may be a stochastic estimator of the trace of the empirical variance covariance matrix which may be used at each step of the policy update to train the proposal. That is, the proposal distribution may be adapted by a gradient variance estimator taking an estimate of variance in the policy adaptation as input. As mentioned earlier, gradients are computed based on this loss and propagated to the proposal parameters. This may comprise the steps of; making a first estimation of noise, or variance, in the policy adaptation; making a second estimation of the extent to which that noise is dependent on the proposal; and adapting the proposal distribution in dependence on the second estimation.

The main advantage of this form of proposal distribution, which replaces the base distribution of the transition model and policy during training of the policy, is that it can be made arbitrarily close to those distributions. A proposal should cover much of the distribution it is replacing. A proposal that would be distant from these distributions would produce unstable trajectories, providing little and unreliable information about the direction of the updates.

FIG. 2 shows a flow chart of the proposed approach 200. The proposed approach substitutes the starting state or base distribution 102 with a proposal distribution 202 over auxiliary variables used for trajectory simulation. The trajectories are typically sequences of states and actions. The auxiliary variables may be pseudo-random numbers. In practice, these auxiliary random variables, together with the initial state, deterministically determine the trajectory that is sampled. The scope is to sample them in such a way that the variance of the policy updates are reduced. Then, weighted returns of the simulated trajectories are estimated 206 and noisy policy gradients 208 are retrieved. The weights are computed in such a way that the estimation of the trajectory is, on average unbiased. These gradients are passed back 210 and used to update the policy 204 using a given stochastic optimizer. From this gradient estimate, another loss is derived, for the proposal distribution 202 this time. A stochastic or noisy estimate of the policy gradient variance may be derived. Similar to what was done for the return and policy, a gradient of the variance estimate with respect to the proposal distribution parameters is derived. This gradient now becomes the signal 212 used to update the proposal distribution's 202 parameters, which may use another stochastic optimizer.

A model-based methodology may be used to solve Equation 1, as it offers a sample efficient alternative to model-free-type algorithms. Rather than directly learning a policy from environmental interactions, MB-RL operates by first building surrogate models, also known as transition models, of both the dynamics and possibly also the rewards.

Formally, with well-behaving surrogate models at-hand, the control step in MB-RL may be written as a problem of finding an optimal policy to a surrogate MDP, [symbol] ₛᵣ= [symbol] [symbol] , [symbol] , [symbol] ₛᵤᵣᵣ, [symbol] ₛᵤᵣᵣ, γ [symbol] , where [symbol] ₛᵤᵣᵣ, [symbol] ₛᵤᵣᵣ are used to indicate learnt transition and reward models. In other words, the agent attempts to find θ* by solving:

$${arg max}_{θ} \overline{𝒥 ( θ )} {=}^{△} {arg max}_{θ} {𝔼}_{\overline{{p}_{θ}} ( τ )} [ 𝒢 ( τ ) ] , \qquad ( 2 )$$

with p̅_̅{̅θ̅}̅(τ) being the density of trajectories obtained from [symbol] ₛᵤᵣᵣ and [symbol] ₛᵤᵣᵣ while following π_{θ}.

When the transition model is unknown, this objective is usually achieved alongside another model-specific objective that minimises a measure of discrepancy between observed and predicted transitions. A variety of algorithms with roots in stochastic optimisation, dynamic programming, model-predictive control, and Monte-Carlo tree search may be used for determining such an optimal policy. Often these methods use sampling, approximations, or both to compute either the utility function [symbol] or its gradient ∇_{θ} [symbol] as the expectations in Equation 2 are almost always intractable.

In the presently proposed method, the focus is on this subset of frameworks where control is optimised through simulation. In general, Monte Carlo samples of trajectories are retrieved from the transition model and the policy, conditioned on a visited start state. With these simulations in hand, it is then possible to perform updates of the policy parameters. Inevitably, as the policy deviates from the one used to collect data in the environment, so does the transition model. Episodes of data collection in the real environment may be interleaved at regular intervals as a consequence.

In order to apply the proposed method, the following two assumptions about the task to be solved may be made.

Assumption 1—the gradient estimator of the objective in Equation 2 can be expressed as a sum of sub-objectives gradients, over each of the steps of a trajectory.

$$= \frac{1}{Z} {Σ}_{k = 1}^{K} {Σ}_{t = 1}^{H} {∇}_{θ} {f}_{t} ( {x}_{t , k} , {u}_{t , k} ; θ ) \qquad ( 3 )$$

for some normalisation constant Z and K simulated trajectories.

Assumption 2—the trajectory can be reparameterised as a function of an auxiliary random variable Y=T_{θ}⁻¹(X)⊆ [symbol] ^{(d}^{ₓ}^{+d}^{ᵤ}^{)×H} where X: Ω→ [symbol] ₁× [symbol] ₁× [symbol] ₂×. . . × [symbol] is a random variable whose realisations are the simulated trajectories τ˜p̅_̅{̅θ̅}̅(τ). Furthermore, it is assumed that T_{θ}⁻¹(X) is differentiable with respect to X.

When it comes to estimating gradients given Monte-Carlo samples of a function realisation, one may generally contrast the likelihood ratio (LR) estimator with reparameterised techniques (RP). The LR estimator is derived by using Fisher's identity.

$${∇}_{θ} \overline{𝒥 ( θ )} = {∇}_{θ} {𝔼}_{\overline{{𝓅}_{θ}} ( τ )} [ 𝒢 ( τ ) ] = {𝔼}_{τ ∼ \overline{{𝓅}_{θ}} ( τ )} [ {∇}_{θ} log \overline{{𝓅}_{θ}} ( τ ) 𝒢 ( τ ) ] \qquad ( 4 )$$

Which enjoys the following unbiased and consistent Monte Carlo estimator.

$$= \frac{1}{K H} {Σ}_{k = 1}^{K} {Σ}_{t = 1}^{H} {∇}_{θ} log {π}_{θ} ( {u}_{t}^{( k )} \vert {x}_{t}^{( k )} ) {ℓ}_{t} ( {x}_{t} , {u}_{t} ) \qquad ( 5 )$$

where [symbol] ₜ is some utility function of the trajectory at time t.

The aim of the proposed approach is to construct a gradient variance reduction algorithm that works in both the LR and RP settings, when both the model and the policy are stochastic. To that end, Filtering Reparameterised RL, FiRe-RL, is described. FiRe is a model-agnostic framework that equips model-based agents with proposal sampling distributions to ensure reduced gradient variances. Apart from enabling efficient gradient propagation through models and environments, FiRe may also serve as a general sampling rule for MB-RL irrespective of whether using deep network or probabilistic dynamical models.

Filtering Reparameterised Reinforcement Learning, or just FiRe, relies on an importance weighted policy update scheme where a proposal sampling distribution is explicitly trained to produce well-behaved trajectories.

### Optimal Proposal Distribution

To collect a set of samples from a distribution P, one has two implementation options to consider. Either the distribution P is sampled from directly, or a surrogate distribution, also called a proposal, Q is used to achieve this. The first option is a special case of the second option. When P≠Q, techniques such as acceptance/rejection, weighting or re-sampling of the samples should be used to correct for the bias introduced by the usage of an alternative distribution. In the importance sampling case, it is a standard result for Monte Carlo sampling that the distribution with density q that minimizes the variance with respect to a given function f on the multivariate random variable X with distribution P and density p is not to P itself but is given by Equation 6.

q*(x)∝p(x)∥f(x)∥ (6)

As described above, in policy gradient RL settings, the objective is typically to retrieve an unbiased estimator for the utility function expected gradient with respect to the policy parameters. However, Equation 6 is not in a form which can be applied to the problem of minimising the total variance of the gradient as it takes the form of a sum of sub-objectives, as shown in Equation 3. Also, in this form, Equation 6 is of little use as the choice of q is motivated by the knowledge of the shape of f, which is generally not known. Therefore, for the proposed approach an alternative option, which is to learn a parametric proposal distribution q_{ϕ} that minimises the total variance of the average gradient estimator is used. The resulting joint objective may then be formulated as in Equation 7.

$${arg max}_{θ} \overline{𝒥 ( θ )} = {𝔼}_{{q}_{{ϕ}^{★}} ( τ )} [ 𝒢 ( τ ; {ϕ}^{★} ) ] \qquad ( 7 )$$

$$s . t . {ϕ}^{★} = {arg min}_{θ} Tr [ {𝕍ar}_{{q}_{ϕ ( τ )}} [ μ ( {∇}_{θ} 𝒢 ( τ ; ϕ ) ) ] ]$$

where μ(∇_{θ} [symbol] (τ; ϕ)) is an estimator of the gradient of the average return that is yet to be defined, and [symbol] (τ; ϕ) is a weighted version of the trajectory average total discounted return.

Importantly, in the family of model-based problems considered herein, the variance of the gradients retrieved has distinct origins. This is the stochasticity of the starting state, the policy, and the transition model. Thus, in this context there is proposed a choice of proposal distribution over the joint state-action space, which is an approach that is not part of existing proposals used in RL. For instance, proximal policy optimisation algorithms, and other importance sampling tools in MF-RL, are restricted to proposals that sample from the action space only, whereas Probabilistic Inference for Particle-Based Policy Search algorithms rely on proposal distributions over the environment model only.

### Flexible and Trainable Proposal using Normalizing Flows

The choice of the proposal is a key aspect of any importance sampling algorithm. In most cases, the optimal proposal cannot be retrieved in closed form. The objective of the proposed method is to aim for a general method by which to learn a proposal distribution that minimises the average gradient variance, while keeping the solution as versatile as possible, computationally inexpensive, and robust to the ever-changing policy and model during training. Regarding this last point, and as can be seen in Equation 6, the proposal density should correlate with the density of the distribution of interest. If most samples are drawn in locations of low density, the resulting weights will have a high variance and the particles will be of poor quality. The non-stationarity of the proposal objective over policy training constitutes another challenge that can be hard to overcome. Small changes in the model or policy parametric distributions can have devastating effects on the proposal efficiency if p̅_̅{̅θ̅}̅ and q are not tied together in some way. Therefore, a distribution is used that passively adjusts the joint transition model and policy in a conservative manner. That is, whose divergence to p̅_̅{̅θ̅}̅ can be made arbitrarily small and robust to changes with little effort.

This distribution takes the form of a Normalising Flow (NF). That is, a sequence of smooth bijective transforms applied to a random variable generated according to a known distribution. The proposed approach consists of using the NF to generate the auxiliary variable used to produce samples from the joint target distribution. These sample may possibly be reparameterized.

Using the change of variable rule, it is possible to express expectations as:

$${𝔼}_{\overline{{p}_{θ}}} [ f ( τ ) ] = {\int }_{X} f ( τ ) \overline{{p}_{θ}} ( τ ) d τ = {\int }_{Y} f ( {T}_{θ} ( ξ ) ) {( abs \vert {∇}_{ξ} {T}_{θ} ( ξ ) \vert )}^{- 1} {p}_{0} ( ξ ) d ξ = {\int }_{Y} \frac{{p}_{0} ( ξ )}{{p}_{0}^{′} ( ξ )} f ( {T}_{θ} ( ξ ) ) {( abs \vert {∇}_{ξ} {T}_{θ} ( ξ ) \vert )}^{- 1} {p}_{0}^{′} ( ξ ) d ξ = {\int }_{Z} \frac{{p}_{0} ( {T}_{ϕ} ( ζ ) )}{{p}_{0}^{′} ( {T}_{ϕ} ( ζ ) )} f ( {T}_{θ} ( {T}_{ϕ} ( ζ ) ) ) {( abs \vert {∇}_{ζ} {T}_{θ} ( {T}_{ϕ} ( ζ ) ) \vert )}^{- 1} {q}_{0} ( ζ ) d ζ \qquad ( 8 )$$

By using this proposal family the importance weight is now a function of ϕ only and is independent of T_{θ}, hence making the proposal robust to changes in policy and model. For instance, it allows for the selection of a proposal that matches p̅_̅{̅θ̅}̅ almost everywhere by choosing T_{ϕ}≡I_{d} for a d-dimensional random variable ζ.

Referring back to the MB-RL context, the focus is on finding a proposal over a random variable T_{ϕ}: [symbol] ^{d}^{ₓ}^{×T}× [symbol] ^{d}^{ᵤ}^{×T} [symbol] [symbol] ^{d}^{ₓ}^{×T}× [symbol] ^{d}^{ᵤ}^{×T} to produce a random sample of each state-action pair of a trajectory. The proposal consists in interposing a sequence of transforms T_{ϕ}≡T_{ϕ}^{N}∘. . . ∘T_{ϕ}¹(ζ) before the model and policy push-forward map T_{θ}: Y→ [symbol] ₁× [symbol] ₁×. . . × [symbol] _{H}× [symbol] _{H}.

The form of T_{ϕ} can be chosen from a large panel of bijective functions that include radial, planar, coupling, Sylvester, Householder flows and many others. From a notational perspective, due to the form of the proposal chosen being independent of the policy parameters, it can be written that:

$${w}_{ϕ , θ} ( τ ) = \frac{{p}_{θ} ( τ )}{{q}_{ϕ , θ} ( τ )} = \frac{{p}_{0} ( ξ )}{{q}_{ϕ} ( ξ )} ≡ {w}_{ϕ} ( ξ ) .$$

With this equivalence in place, two alternative but equivalent forms of the proposal can be considered, one over the auxiliary variable ξ: q_{ϕ}(ξ) and one over the corresponding trajectories q_{ϕ, θ}(τ)=q_{ϕ}(ξ)(abs|∇_{ξ}T_{θ}(ξ)|)⁻¹.

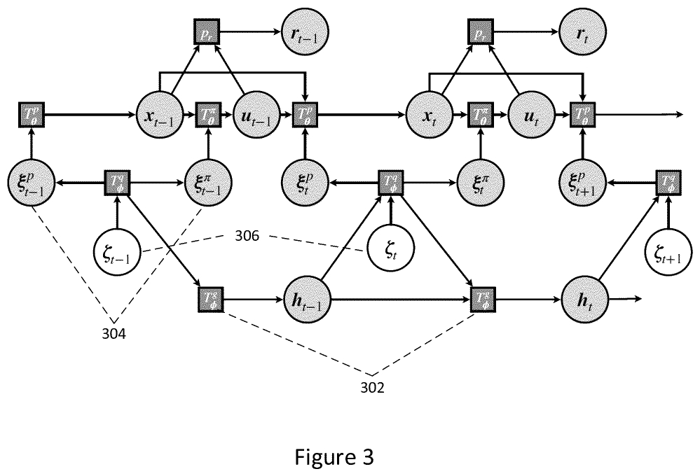

FIG. 3 shows a directed acyclic graph of the data generation process presented in a schematic form. FIG. 3 shows this graph or flow diagram for FiRe trajectories. Parametric distribution maps from their base distributions 302 are marked in squares. Auxiliary random variables 304 are marked in circles. Deterministic transformations 306 of these are marked in circles with a pattern fill. The joint probability and the proposal maps are decomposed in their components, i.e. T_{θ}≡T_{θ}^{π}∘T_{θ}^{p} and T_{ϕ}≡T_{ϕ}^{q}∘T_{ϕ}^{g}, where g_{ϕ} is some given recurrent neural network cell. FiRe generates low variance weighted policy gradient updates by modifying the auxiliary random variables used to generate imagined states and actions.

A sequential Monte-Carlo algorithm aimed at solving the above-described problem is proposed. This is a Sequential Monte Carlo (SMC) algorithm where a proposal distribution is used to retrieve trajectories with a low-variance gradient update. Considering a distribution

$${q}_{ϕ , θ} ( τ ) ≡ {v}_{0} ( {x}_{1} ) {π}_{θ} ( {u}_{1} \vert {x}_{1} ) {\prod }_{t = 2}^{H} {q}_{ϕ , {θ}_{t}} ( {x}_{t} , {u}_{t} )$$

from which K trajectories are drawn, at any time 1≤t≤H and for any particle 1≤k≤K, it is possible to derive an unbiased estimator of the expected value of

$${𝔼}_{\overline{{𝓅}_{θ}}} [ {f}_{t} ( {x}_{t} , {u}_{t} ) ]$$

using the simple formula of Equation 9.

$$\tilde{μ} ( f ( {x}_{t} , {u}_{t} ) ) = \frac{1}{K} {\sum }_{k = 1}^{K} {\tilde{w}}_{t}^{( k )} {f}_{t} ( {x}_{t}^{( k )} , {u}_{t}^{( k )} ) \qquad ( 9 )$$

where the importance weight \tilde{w}ₜ^{(k)} is given by

$${\tilde{w}}_{t}^{( k )} = {\prod }_{{t}^{′} = 1}^{t} \frac{\overline{{p}_{θ}} ( {x}_{{t}^{′}}^{( k )} , {u}_{{t}^{′}}^{( k )} )}{{q}_{ϕ} ( {x}_{{t}^{′}}^{( k )} , {u}_{{t}^{′}}^{( k )} )} .$$

If the values of \tilde{w}ₜ^{(k)}^{²} and fₜ9xₜ^{(k)}, uₜ^{(k)}) are highly correlated, which is a reasonable assumption if sampling trajectories with high reward, it can be shown that the following biased but consistent estimator has a lower variance than the one displayed in Equation 9:

$$\hat{μ} ( f ( {x}_{t} , {u}_{t} ) ) = {\sum }_{k = 1}^{K} {\hat{w}}_{t}^{( k )} {f}_{t} ( {x}_{t}^{( k )} , {u}_{t}^{( k )} ) \qquad ( 10 )$$

where

$${\hat{w}}_{t}^{( k )} = \frac{{\tilde{w}}_{t}^{( k )}}{{\sum }_{k = 1}^{K} {\tilde{w}}_{t}^{( k )}}$$

is a self-normalised weight.

Both the LR and RP gradient sampling methods can be used with these estimators. To use the RP gradient, a uniformly distributed auxiliary random variable ξ˜P₀ may be used to reparameterise the trajectory according to θ. The difficulty that arises in the context of sequential importance sampling algorithms is that there is not the freedom of performing the change of variable [x,u]ₜ^{(k)}→[x(ξₜ^{(k)}; θ), u(ξₜ^{(k)}; θ)], as [x, u]ₜ^{(k)} has now to be sampled according to q_{θ, ϕ} not p̅_̅{̅θ̅}̅. The RP form of the policy gradient may be estimated using the following biased but consistent estimator

$$\hat{μ} ( {∇}_{θ}^{R P} \overline{𝒢 ( τ ; ϕ )} ) = {\sum }_{t = 1}^{H} {\sum }_{k = 1}^{K} {\hat{w}}_{t}^{( k )} {∇}_{θ} {f}_{t} ( {T}_{θ} ( {T}_{ϕ}^{- 1} ( {x}_{t}^{( k )} , {u}_{t}^{( k )} ) ) ) \qquad ( 11 )$$

where state-action pairs are assumed to be generated according to q_{θ, ϕ}. In other words, the SIS reparameterised policy gradient may be retrieved from a proposed trajectory by weighting the biased reparameterised version of the trajectory according to p̅_̅{̅θ̅}̅.

Unfortunately, the total variance of the estimator given by Equation 11 cannot be derived in closed form, as it involves a ratio of expectations. Using the delta method, we derive the following approximation to the self-normalised gradient total variance:

$$Tr [ 𝕍 {arq}_{ϕ , θ} ( τ ) \hat{μ} ( {∇}_{θ} \overline{𝒢 ( τ )} ) ] = \frac{1}{K T} Tr [ {𝔼}_{{q}_{ϕ , θ} ( τ )} [ {( {\sum }_{t = 1}^{H} {w}_{{ϕ}_{t}} ( {ξ}_{t} ) {δ}_{t} )}^{2} ] ] \qquad ( 12 )$$

where δₜ=∇_{θ}fₜ(xₜ, uₜ)−μₜ and μₜ∇ [symbol] ₚ_{_{θ}}_{(τ)}[∇_{θ}fₜ(xₜ, uₜ)] is the (unknown) expected value of the gradient component at step t.

Equation 6 shows what the optimal proposal could be when using a simple, non self-normalised, importance estimator in the non-sequential case. The proposed variance formula and the use of a self-normalised estimator leads to the self-normalised proposal q_{ϕ}(ξ) that minimises the total variance formula in Equation 12 and is given by Equation 13.

$${q}_{ϕ}^{*} ( {ξ}_{1} ) ∝ {p}_{0} ( {ξ}_{1} ) ‖ {δ}_{1} ‖ {q}_{ϕ}^{*} ( {ξ}_{1} \vert {ξ}_{< t} ) ∝ {p}_{0} ( {ξ}_{t} ) \frac{‖ {δ}_{t} ‖}{‖ {δ}_{t - 1} ‖} for t > 2 \qquad ( 13 )$$

We proceed by recursion: first, we find q*₁≡q*_{ϕ}(ξ₁) using variational calculus by solving:

$$\begin{matrix}0 = {∇}_{{q}_{1}} [ T r [ V a r {q}_{ϕ} ( τ ) \hat{μ} ( {∇}_{θ} \overline{q ( τ )} ) ] + λ ( \int q ( ξ ) d ζ - 1 ) ] \\ = {∇}_{{q}_{1}} {\sum }_{c = 1}^{H} \int {q}_{L} ( {ζ}_{1 : L} ) {w}_{c} ( {ζ}_{c} ) {w}_{1} ( {ζ}_{1} ) {δ}_{c}^{T} {δ}_{1} d {ζ}_{1 : L} + \\ λ = 0 as for {t}^{′} \neq 1 , {∇}_{{q}_{1}} \int {q}_{t} ( {ξ}_{1 : t} ) {w}_{t} ( {ξ}_{t} ) {w}_{{t}^{′}} ( {ξ}_{{t}^{′}} ) {δ}_{t}^{T} {δ}_{{t}^{′}} d {ξ}_{1 : t} \\ = {∇}_{{q}_{1}} {\sum }_{c = 1}^{H} \int {p}_{L} ( {ζ}_{1 : L} ) {w}_{1} ( {ζ}_{1} ) {δ}_{c}^{T} {δ}_{1} d {ζ}_{1 : L} + \\ λ since {q}_{t} ( {ξ}_{1 : t} ) {w}_{t} ( {ξ}_{1 : t} ) = {p}_{t} ( {ξ}_{1 : t} ) \\ = \int \frac{{{p}_{1} ( {ξ}_{1} )}^{2}}{{{q}_{1} ( {ξ}_{1} )}^{2}} {δ}_{1}^{T} {δ}_{1} d {ξ}_{1} + {∇}_{{q}_{1}} {\sum }_{c = 2}^{H} \int {p}_{t} ( {ξ}_{1 : t} ) {w}_{1} ( {ξ}_{1} ) {δ}_{t}^{T} {δ}_{1} d {ξ}_{1 : t} \\ = {∇}_{{q}_{1}} \int \frac{{{p}_{1} ( {ξ}_{1} )}^{2}}{{q}_{1} ( {ξ}_{1} )} {δ}_{1}^{T} {δ}_{1} d {ξ}_{1} + \\ {∇}_{{q}_{1}} {\sum }_{t = 2}^{H} \int {w}_{1} ( {ξ}_{1} ) {\underbrace{\int p ( {ξ}_{1 : t} ) {δ}_{t}^{T} d {ξ}_{2 : t}}}_{{𝔼}_{{p}_{θ}} [ {∇}_{θ} {f}_{t} ( {x}_{t} , {u}_{t} ) ] - {μ}_{t} = 0} {δ}_{1} d {ξ}_{1} + λ\end{matrix} \qquad ( 14 )$$

It follows that q*(ξ₁)∝p*₀(ξ₁)δ₁^{T}δ₁.

The optimal value for q₂≡q_{ϕ}(ξ₂|ξ₂) is then found, and similarly it is found that

$${q}^{*} ( {ξ}_{2} \vert {ξ}_{1} ) ∝ \frac{{p}_{0}^{*} ( {ξ}_{1} , {ξ}_{2} )}{{q}^{*} ( {ξ}_{1} )} {δ}_{2}^{T} {δ}_{2}$$

and substituting q*(ξ₁) into this expression leads to Equation 13 for t=2. The rest follows by recursion.

The total variance can be understood as an expectation of inner products over the trajectories and starting states, which have been omitted for the sake of conciseness, and the following estimator follows:

$$Tr [ 𝕍 {arq}_{ϕ} ] = \frac{1}{{H}^{2}} {\sum }_{k = 1}^{K} {e}_{H}^{T} {\hat{δ}}^{( k )} {\hat{δ}}^{{( k )}^{T}} {e}_{H}$$

where e_{U} is a single vector of length U and \hat{δ}^{(k)} is the self-normalised realisation of δ=[δₜ]ₜ₌₁^{H}∈ [symbol] ^{H×d}^{_{θ}}.

Then, supposing there is access to the function values f_{θ}(x, u): [symbol] ^{d}^{ₓ}^{×K×H}× [symbol] ^{d}^{×K×H} [symbol] [symbol] ^{K×H}, an arbitrary real matrix o∈ [symbol] ^{K×H} may be considered, as well as K realisations of the matrix o∈ [symbol] ^{K×H}. Then, the following identity holds and provides a computable estimate of the K variance components:

$$Tr [ 𝕍 {arq}_{ϕ} ] = \frac{1}{{H}^{2}} {{e}_{K}^{T} ( {M}_{ϕ} {e}_{H}^{T} )}^{2} \qquad ( 15 )$$

$${M}_{ϕ} = {\hat{w}}_{ϕ}^{2} ( ξ ) ⊙ {∇}_{o} [ v {∇}_{θ} [ {y}_{o , ϕ , θ} ( ξ ) ] ] ∈ {ℝ}^{K \times H}$$

$$with {y}_{o , ϕ , θ} ( ξ ) = {\underbrace{{e}_{K}^{T} o ⊙ ( {f}_{θ} ( {x}_{ϕ , θ} ( ξ ) , {u}_{ϕ , θ} ( ξ ) ) - {\hat{μ}}_{θ} ) {e}_{H}^{T}}}_{scalar}$$

where \hat{μ}_{θ} is a self-normalised estimate of the H-long real vector with values [symbol] [f_{θ}(xₜ, uₜ)].

For the task of minimizing the quantity given by Equation 12, the objective may be defined as finding the distribution q_{ϕ} that minimises the loss given by Equation 12 using a reparameterised gradient with respect to the proposal parameters.

The following gradient formula may be derived for the reparameterised proposal distribution optimised by minimising the average gradient variance estimate.

$${∇}_{ϕ} 𝕍 {arq}_{ϕ , θ} \hat{μ} ( {∇}_{θ} \overline{𝒢 ( τ )} ) = - \frac{1}{K {H}^{2}} \times {\sum }_{t = 1 , {t}^{′} = 1}^{H} {𝔼}_{ζ} [ {∇}_{ϕ} {T}_{ϕ} ( {ξ}_{0 , min ( t , {t}^{′} )} ) {∇}_{{ξ}_{\leq min ( t , {t}^{′} )}} {{η}_{t} ( ξ )}^{T} {η}_{{t}^{′}} ( ξ ) ] \qquad ( 16 )$$

$$with {η}_{t} ( ξ ) = {w}_{ϕ} ( {ξ}_{\leq t} ) {δ}_{t} ( {T}_{θ} ( {ξ}_{\leq t} ) )$$

This estimator uses a Double reparameterisation technique to avoid the likelihood ratio terms of the original reparameterised gradient estimate.

The proposed method described above can perform poorly when the sequences are reasonably long, due to the proposal distribution potentially being arbitrarily far from the optimal configuration. One can rely on multiple techniques to diagnose poor particle configurations, for example the Expected Sample Size (ESS)

Several other forms of the described objective of the policy could be used as long as their gradient respects 1. Instead of computing plain simulated returns over trajectories of horizon H, a surrogate value estimation may be used such that returns may be estimated without completing a whole imagined sequence.

For the proposal of the presently proposed method to be implemented, the requirements are flexible and hence the method can be applied to a large set of existing models. A prototypical example of a model on which the proposed method can be applied is Dreamer.

Dreamer is a model-based algorithm aimed at learning policies off-line based on pixels. For example, videos of a robot moving, a car being driven, or a game being played, etc. It was published by Google® in 2019. Pixel-based reinforcement learning is a difficult task, as it requires a feature extraction algorithm to translate the information contained in the image into a meaningful content that can be used by the policy to decide on an action to take. Dreamer builds a low-dimensional embedded representation of the videos using a Convolutional neural network that is trained separately. This makes it possible to learn policies in this embedded space, rather than using the full pixel domain. Stochastic gradient estimates are computed using reparameterisation: the gradients are passed through the simulated trajectories, and hence can suffer from exploding or vanishing values—a typical problem of recurrent models such as this.

The proposed method works by computing an estimation of the variance of the updates online during training of the policy, and then proposes alternative lower-variance trajectories that provide more efficient updates. This is done by plugging the described proposal distribution on top of the model and policy. As such it may be assumed that the model is not changed in any meaningful way.

The proposed method thereby allows for training on longer trajectories, with faster learning rates and using less samples. This makes training more sample-efficient. Hence, fewer interactions with the environment are required to reach a reasonable level of performance. This means a more cost-effective training of an algorithm, which is important when developing robotic policy based on model-based reinforcement learning algorithms. Many more popular MB-RL algorithms may benefit from the proposed method, such as the DeepPILCO and MB-MPO algorithms.

The above-described parametric policy may comprise a neural network model. A parametric policy may be formed by the above-described apparatus or the method. The parametric policy may thus exhibit the above-described qualities as a result of the apparatus or method by which it is formed. There is also proposed herein, a processing apparatus comprising one or more processors configured to receive an input and process that input by means of a parametric policy as described above.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An apparatus for training a parametric policy (204) in dependence on a proposal distribution (202), the apparatus comprising one or more processors configured to repeatedly perform the steps of:
forming, in dependence on the proposal distribution, a proposal;
inputting the proposal to the policy so as to form an output state from the policy responsive to the proposal;
estimating a loss (206) between the output state and a preferred state responsive to the proposal;
forming, by means of an adaptation algorithm and in dependence on the loss, a policy adaption;
applying (210) the policy adaption to the policy to form an adapted policy;
forming, by means of the adapted policy, an estimate of variance in the policy adaptation and
adapting (212) the proposal distribution in dependence on the estimate of variance so as to reduce the variance of policy adaptations formed on subsequent iterations of the steps.

2. An apparatus as claimed in claim 1, wherein the proposal is a sequence of pseudo-random numbers.

3. An apparatus as claimed in claim 1, wherein the proposal distribution is a parametric proposal distribution.

4. An apparatus as claimed in claim 3, wherein the step of adapting the proposal distribution comprises adapting one or more parameters of the proposal distribution.

5. An apparatus as claimed in claim 1, comprising the steps of:
making a first estimation of noise in the policy adaptation;
making a second estimation of the extent to which that noise is dependent on the proposal; and
adapting the proposal distribution in dependence on the second estimation.

6. An apparatus as claimed in claim 1, wherein the proposal distribution is adapted by a gradient variance estimator taking an estimate of variance in the policy adaptation as input.

7. An apparatus as claimed in claim 6, wherein the variance estimator is a stochastic estimator.

8. An apparatus as claimed in claim 1, wherein the proposal is formed by stochastically sampling the proposal distribution.

9. An apparatus as claimed in claim 1, wherein the adaptation algorithm is such as to sample a trajectory in a manner such as to inhibit variance of the adaptation over successive iterations.

10. An apparatus as claimed in claim 1, wherein the adaptation algorithm is such as to form policy gradients and to form the adaptation by stochastic optimisation of the policy gradients.

11. An apparatus as claimed in claim 1, wherein the parametric policy comprises a neural network model.

12. A method for training a parametric policy (204) in dependence on a proposal distribution (202), the method comprising repeatedly performing the steps of:
forming, in dependence on the proposal distribution, a proposal;
inputting the proposal to the policy so as to form an output state from the policy responsive to the proposal;
estimating a loss (206) between the output state and a preferred state responsive to the proposal;
forming, by means of an adaptation algorithm and in dependence on the loss, a policy adaption;
applying (210) the policy adaption to the policy to form an adapted policy;
forming, by means of the adapted policy, an estimate of variance in the policy adaptation and
adapting (212) the proposal distribution in dependence on the estimate of variance so as to reduce the variance of policy adaptations formed on subsequent iterations of the steps.

13. A method as claimed in claim 12, wherein the proposal is a sequence of pseudo-random numbers.

14. A method as claimed in claim 12, wherein the proposal distribution is a parametric proposal distribution.

15. A method as claimed in claim 14, wherein the step of adapting the proposal distribution comprises adapting one or more parameters of the proposal distribution.

16. A method as claimed in claim 12, comprising the steps of:
making a first estimation of noise in the policy adaptation;
making a second estimation of the extent to which that noise is dependent on the proposal; and
adapting the proposal distribution in dependence on the second estimation.

17. A method as claimed in claim 12, wherein the proposal distribution is adapted by a gradient variance estimator taking an estimate of variance in the policy adaptation as input.

18. A method as claimed in claim 17, wherein the variance estimator is a stochastic estimator.

19. A method as claimed in claim 12, wherein the proposal is formed by stochastically sampling the proposal distribution.

20. A method as claimed in claim 12, wherein the adaptation algorithm is such as to sample a trajectory in a manner such as to inhibit variance of the adaptation over successive iterations.
